(19) United States
(12) Patent Application Publication
(10) Pub. No.: US 2009/0260313 A1
(43) Pub. Date: Oct. 22, 2009

(54) METHOD FOR MANUFACTURING FLOOR PANELS AND FLOOR PANEL

(75) Inventor: Martin Segaert, Ieper (BE)

Correspondence Address: BACON & THOMAS, PLLC, 625 SLATERS LANE, FOURTH FLOOR, ALEXANDRIA, VA, 22314-1176, US

(73) Assignee: FLOORING INDUSTRIES LIMITED, Sarl, Bertrange (LU)

(21) Appl. No.: 12/295,657

(22) PCT Filed: Apr. 4, 2007
(86) PCT No.: PCT/IB2007/000987

§ 371 Date: Oct. 1, 2008

(30) Foreign Application Priority Data
Apr. 6, 2006 (BE) 2006/0217

(51) Int. Cl. E04C 2/34; E04B 5/00; B44C 1/22; B05D 3/14

(52) U.S. Cl. 52/592.1; 52/792.11; 216/67; 427/569

(57) ABSTRACT

Floor panel, of the type comprising at least a single- or multi-piece substrate, which at least partially consists of wood or wood-based material, wherein the floor panel, at least at two opposite sides, has profiled edge portions, which at least comprise coupling parts, as well as is provided, at least at one of these sides, with a chamfer, such that the floor panel shows at least a first surface formed by the actual upper side of the floor panel, a second surface formed by the surface of said chamfer, and a third surface formed by the portion of the profiled edge portion extending below said chamfer, wherein at the first, as well as at the second and third surface, coatings are present, a first coating, a second coating and a third coating, respectively, wherein at least one of said coatings is realized as a solidified substance.

This invention relates to a method for manufacturing floor panels, as well as to different embodiments of floor panels.

More particularly, the invention relates to a method for manufacturing floor panels of the type comprising at least a single- or multi-piece substrate, which at least partially consists of wood or wood-based material. Herein, this may relate to floor panels substantially consisting of said substrate, such as massive parquet, or to floor panels having, apart from said substrate, also at least a top layer, such as composed parquet or veneer parquet, the top layer of which usually is performed on the basis of wood, or such as laminate floor panels, which usually have a top layer on the basis of synthetic material. Other examples are floor panels with a top layer of stone or ceramics, such as those known from EP 1 441 086.

It is known that such floor panels may be applied for forming a floating floor covering. Herein, these floor panels, during installation, are coupled at their edges, either by means of a conventional tongue and groove connection, wherein they possible are glued into each other, or by means of mechanical coupling parts providing for a mutual locking of the floor panels, for example, in the horizontal as well as in the vertical direction, for example, such as described in the international patent application WO 97/47834.

The present invention aims at a method by which floor panels of the above-mentioned type may show a series of improved features and/or may be produced in a less expensive or more efficient manner. To this aim, the invention relates to a method for manufacturing floor panels of the type comprising a single- or multi-piece substrate and having, at least at two opposite sides, profiled edge portions, which at least comprise coupling parts, wherein said substrate consists at least partially of wood or wood-based material, with the characteristic that each respective floor panel, whether or not in its finishing stage, is at least partially subjected to a plasma treatment.

By wood-based material, for example, materials are intended which consist of wood flakes, wood chips or wood fibers connected by a binding agent. More particularly, materials are intended which are chosen from the group of OSB (Oriented Strand Board), chipboard and fiberboard, such as, for example, MDF or HDF (Medium or High Density Fiberboard).

The inventive idea of applying the unconventional technique of plasma treatment in the rather traditional wood-processing flooring industry creates entirely new possibilities. For example, qualitatively better floor panels may be manufactured and/or floor panels may be manufactured which can be applied in a broader field of application.

Typically, in other industries, for a plasma treatment highly reactive gas discharges are applied, which comprise ionized, excited or fragmented atoms and molecules and thereby provide the plasma. Therein, the gas discharges are created by generating an electric field in the agent or medium, in this case the gas, situated between said two electrodes. When this electric field is high enough, the normally electrically insulating medium will break down and, in other words, despite its insulating features, indeed will start to conduct electricity. The electric field required for the breakdown largely depends on the medium applied. When the breakdown takes places, it leads to an intense heating of the medium and is it capable to ionize, excite and/or fragment the atoms or molecules present, such that a plasma is created at the location of the breakdown, which usually can be classified under the denomination of “lukewarm plasma”. The atoms and molecules in the plasma can chemically react with surfaces exposed thereto. The resulting features of the plasma-treated surface substantially depend on the chemical properties of the applied medium. Preferably, the medium comprises gases, such as oxygen (O2), hydrogen (H2), nitrogen (N2), or a combination of these, such as air. Other examples of ingredients of media are noble gases, such as helium (He), neon (Ne) and argon (Ar), nitrous oxide (N2O), carbon dioxide (CO2) and the like.

According to the invention, by “plasma treatment” preferably at least one of the following three techniques is understood:
the technique of plasma etching, by means of which a contamination or undesired substance can be removed from a surface, wherein preferably oxygen (O2) or hydrogen (H2) are applied as a medium;
the technique of plasma modification, by which the surface can be altered in such a manner that the properties thereof are changed, for example, this surface will show more inert properties, and wherein preferably nitrous oxide (N2O) or carbon dioxide (CO2) are used as a medium;
the technique of plasma-depositing material or plasma polymerization, by which a thin layer-shaped coating, or a film, with particular properties can be formed. In plasma polymerization, one may start from a mono- or oligomer, for example, C2F4 or C2F6, which is already present in the medium in the gaseous phase or forms the medium as such and, under the influence of the energy of the plasma, is transformed to a polymer, which adheres to the plasma-treated surface.

In the most preferred embodiment, said plasma treatment according to the invention consists of applying material preferably in the form of a coating or a film. As aforementioned, the technique of plasma-depositing or plasma polymerization may be used for depositing material. Herein, the thickness of the provided coating or film preferably is 0.1 to 100 micrometers, and still better 0.1 to 10 micrometers. Depending on the desired function of the film, however, also coatings with a thickness between 10 and 100 micrometers may be applied. The possibility of applying, according to this preferred embodiment, a thin coating or film on a portion of the floor panel by means of plasma treatment, offers the possibility of conferring specific features to certain parts of the floor panel. So, for example, may the plasma treatment consist at least of realizing a moisture-repellent or waterproof layer, and/or of realizing a layer with dirt-repellent and/or antistatic and/or anti-bacterial and/or sound-damping features and/or with a feature altering the gloss degree of the initial surface. Also, the plasma treatment may be applied for a wear-resistant and/or scratch-resistant layer, which preferably offers such features which are better than those of the initial surface.

It is noted that the fact that said film is applied by means of a plasma treatment, such as plasma polymerization, implies particular advantages. So, films formed and/or applied in such manner may show particular molecular structures, crystal structures or other structures leading to new and/or unexpected technical applications thereof. So, for example, a polymer formed by plasma treatment, such as plasma-formed polyethylene, differs from the usual polymer in that the plasma-formed polymer, amongst others, may show an amorphous structure with a higher density. Moreover, a material layer deposited by plasma treatment may show better resistance against ageing and/or better temperature stability. Moreover, a plasma treatment, such as the deposition of material by means of plasma polymerization, may be performed on any type of material. This is of particular importance with floor panels of which the substrate at least partially consists of wood or wood-based material, in view of the fact that plasma treatment also allows to form a thin homogenous film on said wood or wood-based material. In comparison to known techniques, such as, for example, those known from WO 2004/016422, it is possible, by means of a plasma treatment, to apply films of a better quality and/or more constant thickness.

Preferably, the deposited material comprises compounds of fluorine and carbon, such as polymers, which are formed starting from C2F4 or C2F6, which are known to have waters and/or dirt-repellent properties. Other materials which can be deposited by means of a plasma treatment according to the invention comprise, for example, polymers formed starting from CF4, SF6, silicon compounds or the like.

The plasma treatment of the invention may be performed in a vacuum as well as under atmospheric pressure. In the case one works in a vacuum, the plasma treatment preferably takes place in a vacuum chamber provided to this aim. When one works under atmospheric pressure, for example, a beam, whether or not directed, such as a plasma torch, may be used. Preferably, herein the plasma beam will be shielded from the surrounding air by a protective gas. As a protective gas, the same gas can be chosen as the medium in which the plasma has been created. Preferably, however, helium (He) is used as a result of the chemically inert character thereof.

Above, by “vacuum” a pressure is intended that is lower than atmospheric pressure and preferably is less than 500 Pascal, and still better is less than 100 Pascal.

Of course, it is also not excluded that pressures are used for the plasma treatment that are higher than 1 atmosphere.

A first important application of the invention relates to a method wherein said plasma treatment is at least performed at said two opposite profiled edge portions, still better said plasma treatment is performed on all sides of the floor panel, independently of the fact whether or not they are provided with profiled edge portions. A treatment according to this first application is particularly useful when said coupling parts, which form part of the profiled edge portions, are made in one piece with said substrate and at least these coupling parts consist of the aforementioned wood or wood-based material. Possible effects that can be obtained by the plasma treatment of the profiled edge portions are: obtaining water-tightness or waterproofness of the respective edge portions. It is clear that preferably all sides of the floor panel are subjected to a plasma treatment, with the intention of making them waterproof or water-tight, also it is not excluded that solely said two opposite sides are treated with the plasma. At the other sides of the floor panel then, with the intention of obtaining waterproofness or water-tightness of these sides, other measures may be taken, such as, for example, those known from said WO 2004/016422, or such as the application of a separate sealing strip, as known from WO 03/087497.

This first application is particularly useful for treating laminate floor panels. Such floor panels may be of different construction.

Laminate floor panels comprise at least a substrate, a decor, as well as a top layer, wherein the top layer preferably is made on the basis of synthetic material. So, for example, may the top layer consist of a number of carrier sheets, for example, consisting of paper, said sheets being soaked in resin, for example, a melamine resin, such as melamine formaldehyde. In such case, the laminate preferably is made as so-called “DPL” (Direct Pressure Laminate), wherein the top layer is pressed directly onto the core, or so-called “HPL” (High Pressure Laminate”), wherein the top layer as such is obtained by means of a press treatment prior to applying that top layer as a whole on the core. Also, other possibilities for forming such top layer are possible, for example, by making use of foils, by applying a substance that has to be solidified, such as a varnish or the like, or in any other manner. The decor may be formed by a pattern, which is printed either directly onto the core, with the possible intermediary of a primer, or onto one or more of the aforementioned carrier sheets or onto said foil.

By applying said top layers, and in particular said top layers on the basis of synthetic material, already a certain water-tightness or waterproofness may be obtained at the upper side or decorative side of laminate floor panels. However, at the edges where such floor panels can be coupled to each other, there is a zone where moisture possibly may penetrate into the substrate via the profiled edge portions. Such penetration of moisture may lead to a swelling of the substrate and a resultant forming of upstanding edges at the top layer. Said first application of the method according to the present invention may minimize the risk that such upstanding edges are formed. It is noted that forming upstanding edges, whether or not as a consequence of moisture penetration into the substrate, may be minimized with floor panels other than laminate floor panels, too, by means of said first application.

It is clear that, as aforementioned, the coupling of laminate floor panels may take place either by means of a conventional tongue and groove connection, wherein these possibly are glued into each other, or by means of mechanical coupling parts, which provide for a mutual locking of the floor panels in horizontal as well as in vertical directions, for example, as described in the international patent application WO 97/47834. It is in particular with such mechanical coupling parts that a plasma treatment, such as plasma polymerization, is of interest, as, when installing such floor panels, no glue, which as such may have a sealing effect, has to be applied in order to perform the coupling.

It is noted that the first application allows manufacturing floor panels which can also be installed in humid rooms, such as bathrooms.

A second important application of the invention relates to a method wherein said plasma treatment is at least applied to the upper side or decorative side of the floor panel. Hereby, different effects may be obtained, such as, for example, water-tightness, wear resistance and/or a dirt-repellent effect of the upper side or decorative side. It is clear that, also in the case that the floor panel already has a water-tight top layer, such as a top layer on the basis of synthetic material, it may still offer particular advantages to perform a plasma treatment at least on the top layer.

This second application is also particularly important for laminate floor panels, the decor of which is formed by a pattern printed directly onto the core, possibly with the intermediary of a primer or other layer. With this kind of laminate floor panels, then a wear-resistant layer may be formed by means of plasma treatment, whether or not directly on top of said printed pattern.

It is clear that the aforementioned two important applications may be combined and that the entire floor panel, too, possibly with the exception of the bottom side thereof, may be subjected to the plasma treatment.

It is noted that the method of the invention is particularly advantageous in floor panels or laminate floor panels with a substrate consisting of MDF or HDF, in view of the fact that water-tight edge areas may be realized in these floor panels by means of a plasma treatment, independently of the amount of binding agent applied in the production of the respective MDF/HDF substrate. So, for example, does the invention allow forming a waterproof floor panel even if the substrate of the floor panel as such is of a lesser quality, such as MDF/HDF with a high swell degree, for example, a swell degree of more than 20% (measured according to the EN13329 Annex G standard).

Further, it is noted that the invention also relates to a floor panel, with as a characteristic that it is obtained or may be obtained by applying a method according to the invention.

The present invention also relates to a second, third, fourth and fifth independent aspect, the characteristics of which will become clear from the following detailed description herein.

With the intention of better showing the characteristics of the invention, hereafter, as an example without any limitative character, several preferred embodiments are described, with reference to the accompanying drawings, wherein

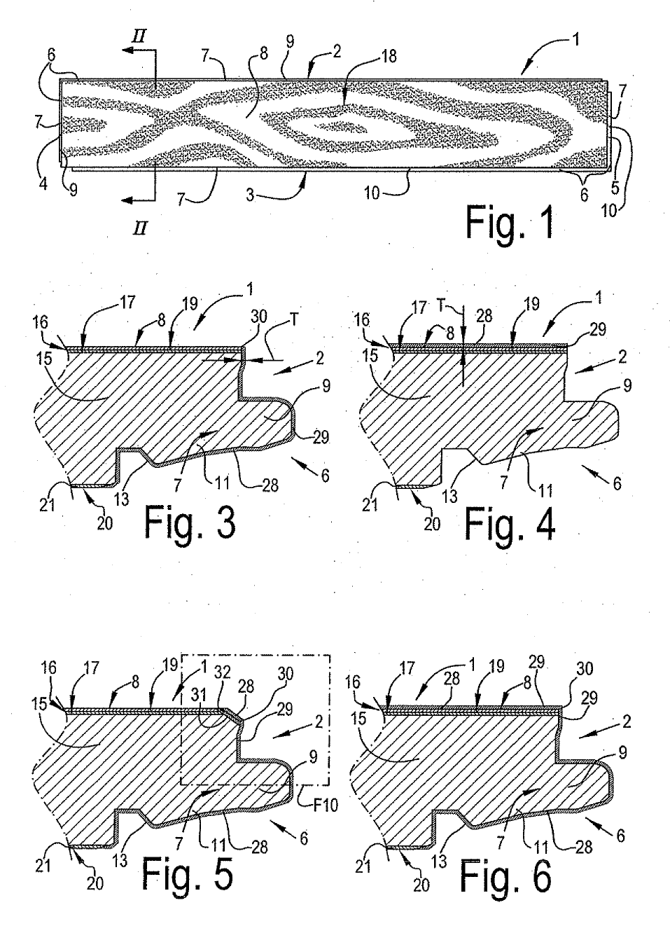

FIG. 1 represents a floor panel that is obtained by applying a method according to the invention;

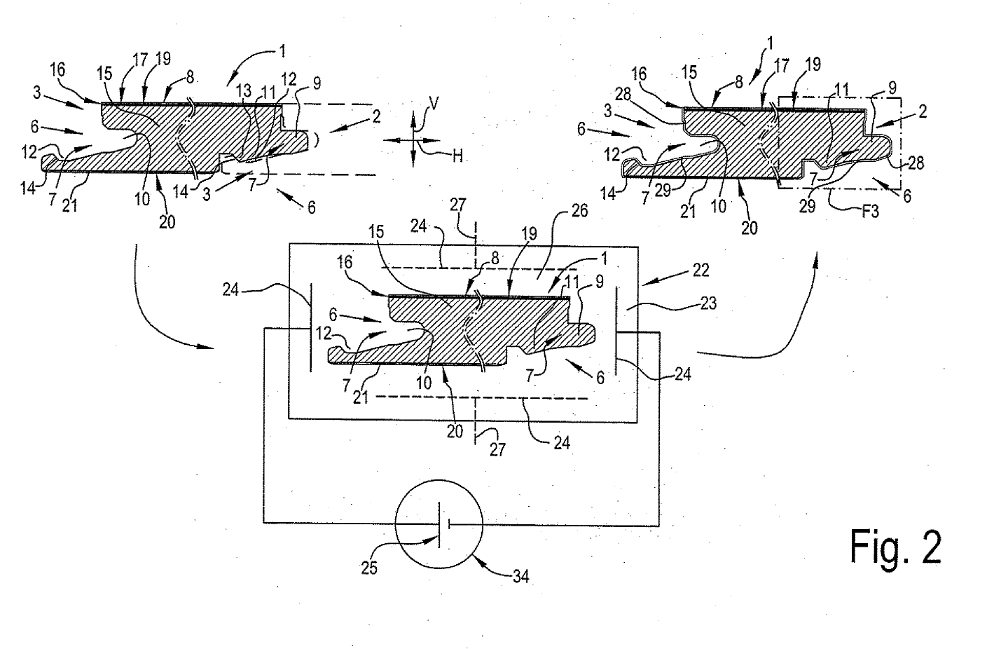

FIG. 2, in a cross-section according to the line II-II represented in FIG. 1, schematically represents several steps of the manufacture of the floor panel of FIG. 1;

FIG. 3, at a larger scale, represents the portion indicated by F3 in FIG. 2;

FIGS. 4 to 7, in a similar view, represent several variants of floor panels which can be obtained by a method according to the invention;

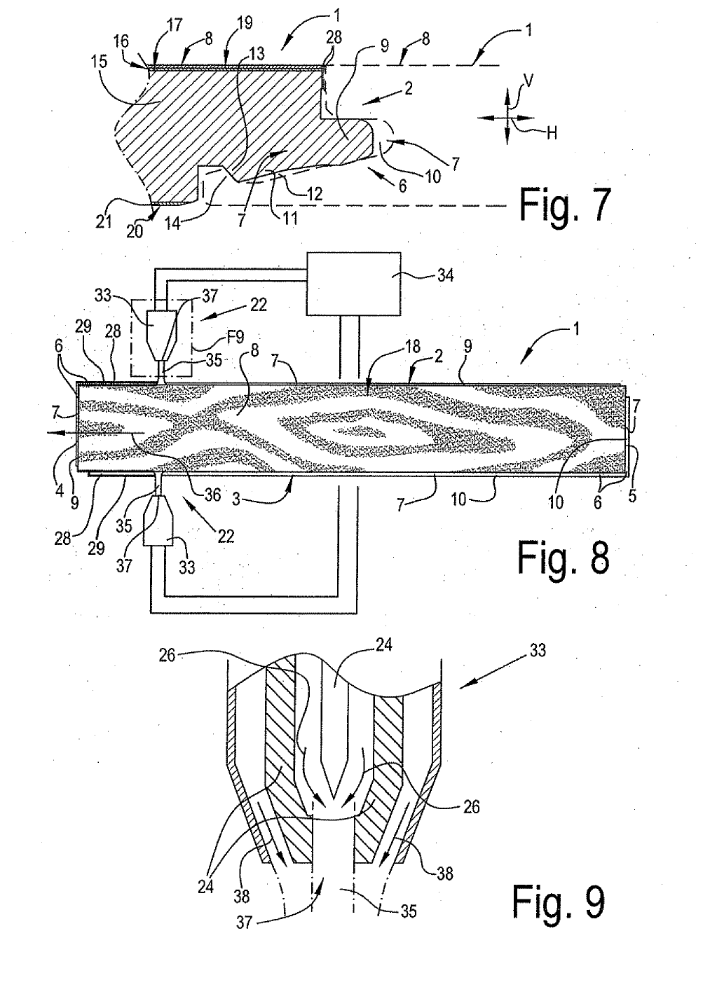

FIG. 8 schematically represents a variant for performing a method according to the invention;

FIG. 9, at a larger scale, represents the portion indicated by F9 in FIG. 8;

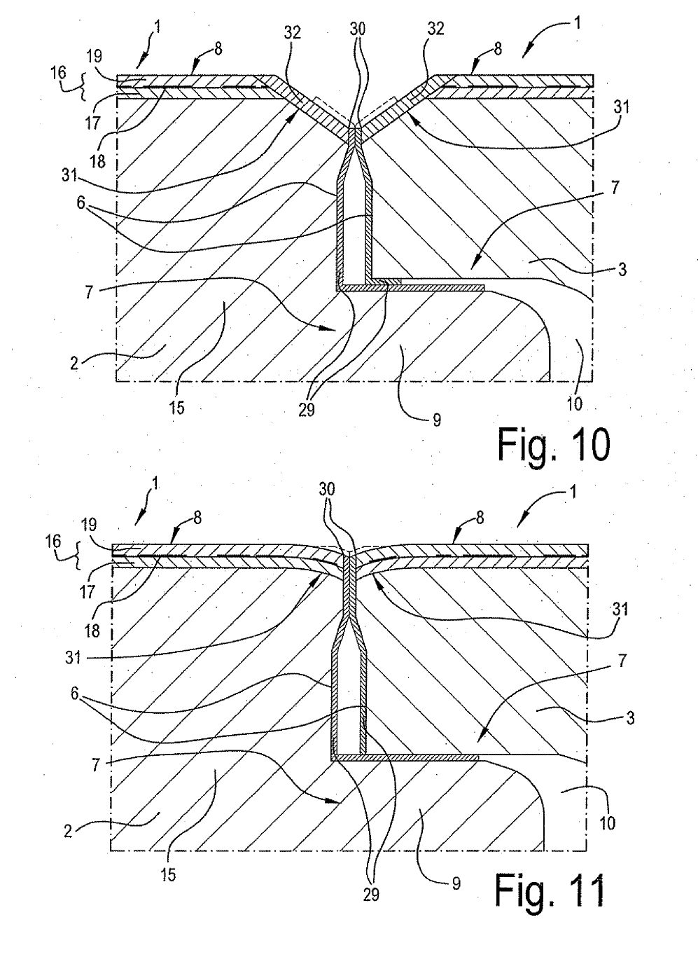

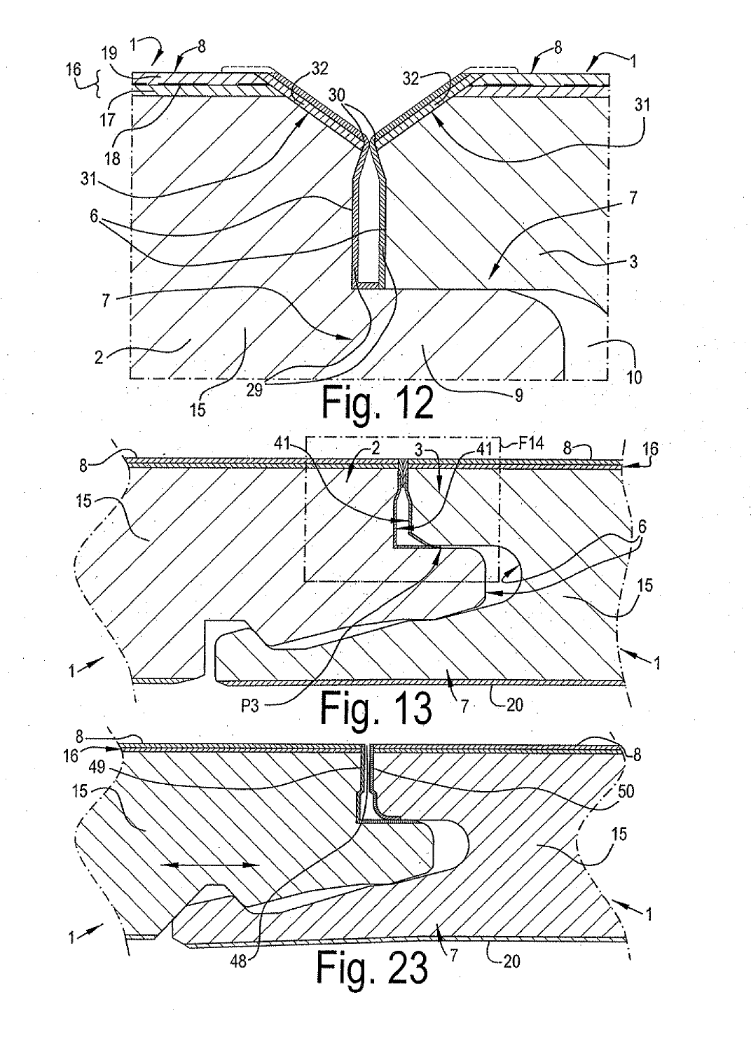

FIGS. 10 to 12 represent a number of embodiments of a particular aspect of the invention, wherein FIG. 10 represents a variant for the portion indicated by F10 in FIG. 5, whereas FIGS. 11 and 12 represent further variants of this portion;

FIG. 13 represents two coupled floor panels, which are realized in accordance with the fourth aspect of the invention;

FIG. 14, at a larger scale, represents the portion indicated by F14 in FIG. 13;

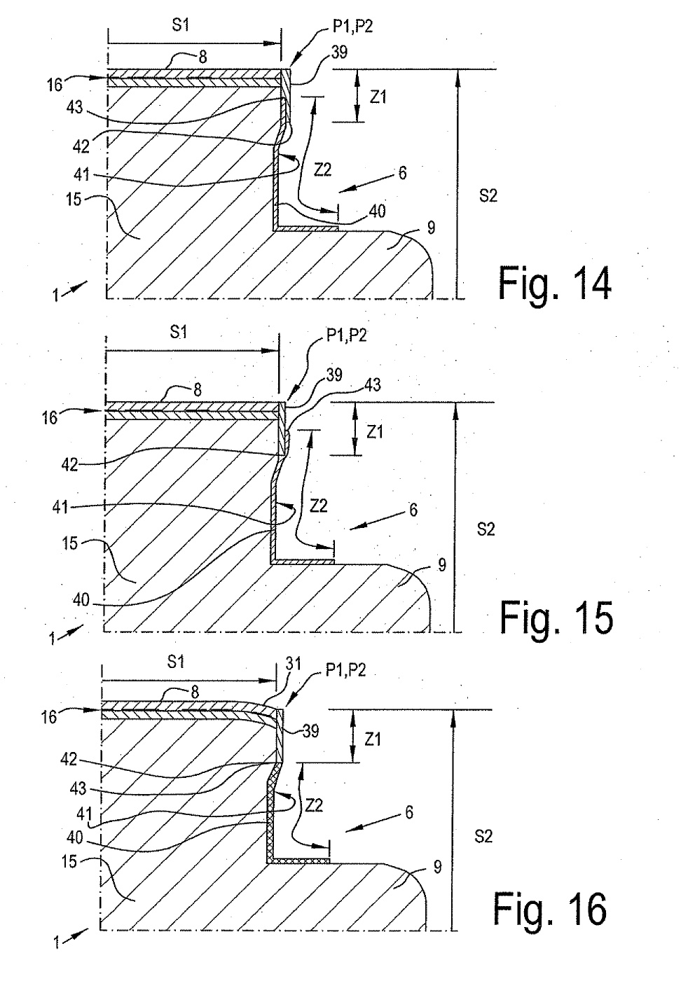

FIGS. 15 to 20 represent a number of variants of the portion depicted in FIG. 14;

FIGS. 21 to 23 represent various forms of embodiments of floor panels fulfilling the fifth aspect of the invention.

FIG. 1 represents an oblong rectangular floor panel 1, which, as represented in FIG. 2, is obtained by means of a method according to the invention. The floor panel 1 shows two pairs of opposite sides, 2-3 and 4-5, with profiled edge portions 6, which comprise mechanical coupling parts 7. The applied coupling parts 7 allow a mutual locking of two of such floor panels 1 in a horizontal direction H as well as in a vertical direction V. For the locking in vertical direction V, this is a direction perpendicular to the upper side 8 of the floor panel 1, the coupling parts 7 represented here are substantially made in the form of a tongue 9 and a groove 10. The locking in horizontal direction H, this is in a direction perpendicular to said vertical direction V and in the plane of FIG. 2, in this case is obtained by providing locking elements in the form of a projection 11 at the underside of the tongue 9 and a recess 12 in the lower lip of the groove 10. When coupling two of such floor panels 1, the locking elements 11-12 cooperate with each other and form the contact surfaces 13-14, which prevent the floor panels 1 from moving apart. Preferably, the applied mechanical coupling parts 7 result in a play-free locking of two of such floor panels in said horizontal direction H and vertical direction V, and still better the coupling parts 7 result in a play-free locking in all directions in the plane determined by said directions V and H.

It is clear that the floor panels 1 obtained by a method according to the invention may have any shape, such as a rectangular, square, hexagonal shape or the like, as well as may be provided with any coupling parts 7.

The floor panel 1 represented in FIGS. 1 and 2 relates to a laminate floor panel 1 comprising a substrate 15, wherein this substrate 15 consists entirely of a wood-based material, such as MDF or HDF. Moreover, said coupling parts 7 are made in one piece with this substrate 15. The floor panel 1 also comprises a top layer 16 on the basis of synthetic material. In this case, the top layer 16 relates to a so-called “DPL” layer, which, in this example, consists of a decorative layer 17 with a printed pattern 18 and a wear-resistant layer 19, such as a so-called overlay, provided thereupon. The decorative layer 17 as well as the overlay 19 comprises a paper layer soaked in resin. Herein, the overlay further also comprises wear-resistant particles, such as corundum. At its underside 20, the floor panel 1 has a backing layer 21, which also comprises a paper layer soaked in resin.

As schematically represented in FIG. 2, the floor panel 1 according to the invention is subjected to a plasma treatment 22. To this aim, the floor panel 1 is brought, for example, into a vacuum chamber 23, in which, by means of two electrodes 24 and a power source 25, a plasma is created in the gaseous medium 26 present in the chamber 23. The electrodes 24 may be erected according to a plurality of possibilities in accordance with the desired result. An alternative positioning of the electrodes 24 is illustrated in dashed line 27.

For the plasma treatment 22 represented in FIG. 2, the technique of plasma-depositing material 28 or plasma polymerization is applied. Herein, the plasma treatment 22 consists of providing material 28, such as material 28 comprising fluorocarbon compounds, in the form of a film 29 on the profiled edge portions 6, said film providing for that the respective sides 2-3 or 4-5 become waterproof or water-tight. Of course, it is preferred that herein the profiled edge portions 6 of all sides 2-3-4-5 are treated.

FIG. 3 shows, at a larger scale, the result of this method. It is noted that the thickness T of the film 29 is represented in an exaggerated manner. In reality, the thickness T may be in the submicron range. Notwithstanding the small thickness T, as represented, by means of the plasma treatment still a film 29 of very homogenous thickness T may be obtained. The possibility of applying a thin homogenous film 29 of a certain material 28 on the coupling parts 7 by means of a plasma treatment provides for that the film 29 can be applied such that it does not form an obstacle for obtaining a good coupling of two of such floor panels 1.

It is clear that a plasma treatment 22, and in particular the one represented schematically in FIG. 2, may be performed simultaneously on several floor panels 1, or that several floor panels 1 may be in the vacuum chamber 23 at the same time.

FIG. 4 shows the result of a plasma treatment 22 performed on said top layer 16. In this application, it is desirable, surely in the case of a laminate floor panel 1, that the applied film 29 is transparent, such that the underlying decorative layer 17 remains visible, even if a slight loss of transparency might occur. In view of the fact that a plasma treatment allows to apply a film 29 of small thickness T, such treatment 22 is also particularly suitable for providing a film 29 on said top layer 16 with a minimum loss of transparency. As aforementioned, such film 29 may have, for example, a dirt-repellent effect or may enhance the scratch or wear resistance of the upper side 8 or decorative side.

FIG. 5 represents a variant, wherein the profiled edge portion 6 at the upper edge 30 also shows a chamfer 31, in this case with the shape of a bevel. The represented chamfer 31 or bevel is provided with a separate decorative coating 32 and remains visible at the decorative side or upper side 8 after coupling of two of such floor panels 1. In this example, the film 29 applied by means of plasma treatment 22 is made overlapping with the chamfer 31. As mentioned in respect to FIG. 4, it is possible to perform the film 29 such, by means of plasma treatment 22, that there is almost no loss of transparency, such that said separate decorative coating 32 can remain well visible.

FIG. 6 shows another variant in which the upper side 8 as well as the profiled edge portions 6 of the floor panel 1 are subjected to a plasma treatment 22. Preferably, in such plasma treatment 22 a material 28 is deposited that comprises fluorocarbon compounds, such as polymers formed starting from C2F4 or C2F6. At the upper side 8, then the dirt-repellent effect of such material 28 may be applied in a useful manner, whereas at the height of the profiled edge portions 6 the waterproofing properties of these materials 28 may be applied.

According to a non-represented variant, by means of the film realized by the plasma treatment, also an entire or almost entire encapsulation of the floor panel may be provided.

FIG. 7 shows a variant, wherein the film 29 substantially is deposited there, where the floor panels 1 are intended to adjoin each other.

It is clear that in the examples of FIGS. 3 to 6, the non-represented groove side 3-5 of the floor panel 1 preferably has undergone a similar treatment 22 and that still better all sides 2-3-4-5 of the floor panel 1 have been subjected to such plasma treatment 22.

FIG. 8 represents a variant of the method according to the invention, wherein the plasma treatment 22 takes place under atmospheric pressure. To this aim, in the example plasma torches 33 are used instead of a vacuum chamber 23. The torches 33 are connected to a generator 34, which supplies the power to generate the plasma 35 in the torches 33. Herein, the plasma 35 leaves the torches as a beam and is cast onto the portions to be treated of the floor panel 1, in this case at least the profiled edge portions 6 thereof. Due to the limited beam diameter of the plasma 35, it is necessary to displace the floor panel 1 relatively along the torches 33, such as indicated by arrow 36. By such method, it is possible to subject the floor panels 1 one by one to the plasma treatment 22. Such method may induce an efficient performance of the method of the invention.

FIG. 9 schematically illustrates the working of such plasma torch 33. In the example, the two electrodes 24 required for generating the plasma 35 are erected concentrically. The medium 26 or gas in which the plasma 35 is generated, flows axially in between the electrodes 24 and exits the torch 33 together with the plasma beam 35 via the nozzle 37 of the plasma torch 33. With the intention of shielding the plasma beam 35, amongst others, against cooling by the surrounding air, preferably a protective gas 38 is applied. As represented in FIG. 9, this protective gas 38 also flows axially out of the plasma torch 33 and thus forms a shield around the plasma beam 35.

It is noted that in general for generating the plasma 35 preferably an alternating current is used, with a frequency that is higher than 1 gigahertz.

Further, it is noted that the plasma treatment does not necessarily have to take place when the floor panels already have been provided with their profiled edge portions, but that such plasma treatment according to the invention may be performed at any moment in the manufacturing process of the floor panels. So, for example, in the case of a method in which several floor panels are obtained from a larger board, the plasma treatment also may be implemented on this larger board. Such method is particularly useful for realizing a dirt-repellent film on a top layer. The latter, of course, under the condition that the top layer is already present on said larger board, such as this is the case, for example, with the top layer of a floor panel formed by means of a DPL process.

It is noted that, if a wear-resistant layer is provided by means of the plasma treatment, this layer possibly may be chosen such that no separate wear-resistant particles, such as corundum, have to be applied in the conventional underlying material layers, for example, in the overlay in the case of DPL. Also, such particles possibly may be attached to the upper surface via the plasma treatment, as a consequence of which the difficult process of mixing corundum or the like into resin and impregnating, for example, an overlay with this may be excluded.

According to a second independent aspect, the present invention relates to a floor panel 1 of the type comprising at least a single- or multi-piece substrate 15 and having a top layer 16 at its upper side 8, wherein the floor panel 1, at least at two opposite sides 2-3, has profiled edge portions 6, which at least comprise coupling parts 7, and wherein the substrate 15 consists at least partially of wood or wood-based material, with the characteristic that the floor panel 1, on one or more of said profiled edge portions 6, has a transparent or translucent moisture-repellent film-shaped coating 29, whether or not covering the entire surface of the respective profiled edge portions and extending from on the surface of the respective profiled edge portion 6 up to said upper side 8 of the floor panel 1.

Preferably, all sides 2-3-4-5 or profiled edge portions 6 of the floor panel 1 show the characteristics of this particular independent aspect. Of course, for manufacturing such floor panels 1 the method may be used that is described in the introduction. However, this particular aspect is not restricted to coatings 29 obtained by means of a plasma treatment 22.

It is clear that in the second aspect, by the upper side 8 the visible upper surface is intended, including possible surfaces of chamfers 31 situated at the decorative side.

The transparency of said film-shaped coating 29 may be obtained by the choice of the coating material 28 and/or by limiting the thickness T of the coating 29.

Embodiments of this particular aspect are represented in FIGS. 5 and 6. By a film-shaped coating 29 extending from on the respective profiled edge portion 6 up to the upper side 8 of the floor panel 1, it is obtained that the floor panels 1 may be manufactured in a simpler manner. Namely, in such case no or little consideration must be given to avoiding or preventing that the upper side 8 of a floor panel 1 with the film 29 is soiled, as a film 29 is obtained extending at least up to the upper edge 30 of the floor panel 1, which is desirable, for example, when applying a waterproofing film.

It is noted that this particular independent aspect is particularly useful when the substrate 15 consists of wood-based material, such as MDF or HDF. This may be the case, for example, with the above-described floor panels also mentioned in the introduction.

Irrespective of the examples described above by means of FIGS. 5 and 6, it is noted that floor panels according to the second aspect further may also show one or more of the following characteristics:
that the floor panel, on all sides 2-3-4-5 or profiled edge portions, shows a film-shaped coating 29 extending from on the respective side or from on the respective profiled edge portion 6 up to said upper side 8 of the floor panel 1;
that the film-shaped coating 29 is formed by a substance solidified during or after application, for example, a varnish, lacquer, polymer or the like;
that the film-shaped coating 29 forms a watertight or substantially watertight layer;
that the film-shaped coating 29, whether or not together with a moisture-repellent or watertight top layer 6 at the upper side 8 of the floor panel 1 and whether or not together with a moisture-repellent or watertight layer 21 at the underside 20 of the floor panel 1, effects an entirely complete moisture-repellent or watertight encapsulation;
that the film-shaped coating 29 is provided around the actual floor panel 1 in an entirely encapsulating manner;
that the film-shaped coating 29 is composed of materials 28 or comprises materials 28 which offer additional advantages, for example, in respect to wear resistance, scratch resistance, dirt repellency, antistatic effect, and so on.

According to a third aspect, the invention relates to a floor panel of the type that comprises at least a one- or multi-piece substrate consisting at least partially of wood or wood-based material, wherein the floor panel, at least at two opposite sides, has profiled edge portions comprising at least coupling parts, as well as is provided with a chamfer at least at one of these sides, such that the floor panel has at least a first surface formed by the actual upper side of the floor panel, a second surface formed by the surface of said chamfer, and a third surface formed by the portion of the profiled edge portion extending below said chamfer, with as a characteristic that coatings are present at the first, as well as the second and third surfaces, a first coating, a second coating and a third coating, respectively, wherein at least one of said coatings is implemented as a solidified substance.

By the third surface, herein a surface is meant that normally is not visible at the viewing side of the installed floor panels. By “the actual upper side”, the decorative side of the floor panel is meant, with the exception of the surface of the chamfers.

Floor panels according to this third aspect offer the advantage that, due to the application of said three coatings on the respective three surfaces, a broad range of possibilities is created for providing, in function of a desired effect, an optimum covering of the respective surfaces.

According to a particular form of embodiment, the floor panel according to the third aspect is characterized in that the first, second and third coatings each are separate coatings, which preferably each have been applied by separate techniques.

According to another particular form of embodiment of the third aspect, the floor panel is characterized in that the first and second surfaces are provided with the same coating, which then partially functions as the first and partially as the second coating, whereas the third coating has been performed separately, and preferably differently.

According to still another form of embodiment of the third aspect, the floor panel is characterized in that the second and the third surfaces are provided with the same coating, which then partially functions as the second and partially as the third coating, whereas the first coating has been performed separately, and preferably differently.

Possibly, the first and second coatings may be realized in an overlapping manner. The same is valid, for example, for the second and the third coating. Such overlaps offer the advantage that a good adjoining is created, without untreated intermediate zones. By “overlapping” herein is meant that there is an explicit overlap and that this does not relate to an overlap occurring in an undesired manner or sporadically, because one of the adjacent coatings has been provided not very accurately and therefore sometimes exceeds the borderline between the two coatings.

For the first coating, use is preferably made of any of the following possibilities:
a laminate layer, whether or not as such composed of several layers, on the basis of resin, such as, for example, HPL (High Pressure Laminate) or DPL (Direct Pressure Laminate);
a foil;
a lacquer or varnish;
a polymer;
an ink, possibly in the form of a print, wherein this ink has been provided by means of an inkjet principle or another application principle.

For the second coating, preferably use is made of any of the following possibilities:
a foil;
a transfer film;
a lacquer, varnish, or ink, wherein this ink has been provided by means of an inkjet principle or another application principle;
a polymer.

For the third coating, preferably use is made of any of the following possibilities:
a foil;
a transfer film;
a lacquer, varnish, or ink, wherein this ink has been provided by means of an inkjet principle or another application principle;
a polymer;
a moisture-repellent substance, which preferably is transparent and still better is clear.

According to the third aspect, it is not excluded that the first, the second as well as the third surfaces are provided with one and the same coating, more particularly a common coating, which then partially functions as a first, as a second, as well as a third coating, wherein this common coating then is realized as a solidified substance. Such solidified substance may simply be applied continuously over said three surfaces, whether or not above coatings situated there below. So, for example, may the top layer consist of a laminate layer, whereas the chamfer has a separate decorative layer, whereas the first, second and third coatings consist of a one-piece layer of a transparent moisture-repellent material, wherein this layer covers the entire surface of the chamfer, however, also partially continues over the actual upper side of the panel and also partially continues from the underside of the chamfer over the third surface situated there below.

In an important preferred form of embodiment of the third aspect, the floor panel is a laminate floor panel, with a top layer on the basis of resin, said top layer forming the first coating, and wherein the second and third coatings are realized in one piece by means of a colorant layer, more particularly a lacquer layer. In this manner, by means of one application treatment, the surface of the chamfer may be decoratively colored, as well as a moisture-repellent and possibly water-tight layer may be provided on the third surface, at least on the portion of this third surface situated directly below the surface of the chamfer.

According to another important preferred form of embodiment, the floor panel is a laminate floor panel, with a top layer on the basis of resin, which top layer forms the first coating, wherein the second coating is made as a decorative layer, whether or not integrally made with the first coating, and wherein the third coating consists of a moisture-repellent layer, which is made partially overlapping with said second coating. More particularly, herein it is preferred that the third coating consists of a transparent layer, whereas the second coating consists of a decorative layer. The decorative layer confers a desired color effect or a desired print to the surface of the chamfer and preferably also provides for a moisture-repellent effect. The third coating preferably provides for a moisture-repellent effect at the surface situated below the chamfer. Due to the overlap, it is obtained that no untreated transitions between the second and the third surface are created. As the overlap, however, ends on top of the second coating and thus does not extend up to the first coating, a possible transition is hardly visible to the naked eye, as such transition is situated in the chamfer.

The invention in particular shows its advantages in the case that the floor panel is a laminate floor panel with a core on the basis of MDF or HDF and with a top layer formed by DPL (Direct Pressure Laminate), and with floor panels that can be coupled in a mechanical manner. Thus, said coupling parts preferably are of the type which, in coupled condition of two of such floor panels, offers a locking in vertical and horizontal directions.

It is clear that the aforementioned first and/or second and/or third coating may be provided directly or indirectly on the substrate. In the case that they are not provided directly, this means that another coating, of which kind whatsoever, is present beneath the first and/or second and/or third coating.

The invention in particular shows its advantages in the case that a third coating is provided, which covers a substantial part of the surface of the profiled edge portion, in other words, a coating extending over a relatively considerable portion of the contour of the coupling parts. In the case that the coupling parts consist of a tongue and groove structure at which locking means are provided for a horizontal locking, it is preferred that, in respect to the tongue side, the third coating extends from the chamfer as far as against and still better as far as onto the upper side of the tongue, and/or, in the case of the groove side, this coating at least extends up to the upper side of the groove and still better also at least partially along the upper flank of the groove.

According to a preferred form of embodiment of a floor panel according to the third aspect, the coupling parts are substantially made as a tongue and groove, which further have locking means for a horizontal locking, and a third coating is provided at the tongue side as well as at the groove side, each time over such a surface that, when two of such floor panels are coupled to each other, the third coating of the tongue side and the third coating of the groove side extend from the respective chamfer downward, at least so far that they both extend at least up to the upper side of the tongue, where they adjoin against each other in the coupled condition. This construction is particularly useful for obtaining a moisture-repellent sealing, for example, for floor panels, more particularly laminate panels, which are specifically intended for moist rooms, such as bathrooms and the like. In fact, it is so that with floor panels provided with chamfers, at the location of these chamfers, so to speak, reservoirs are created, in which moisture and water may be present for a prolonged time, and thus it is also useful to provide for a sufficient protection of the substrate and to build in sufficient barriers for water penetration, such that this penetration remains limited to portions protected by said third coating, after which the penetrated moisture, as it is blocked by the coating, gets enough time to subsequently escape by evaporating into the ambient air.

FIGS. 10, 11 and 12 represent a number of embodiments fulfilling the third aspect of the invention.

In FIG. 10, for example, the top layer 16 functions as a first coating, the separate decorative coating 32 on the chamfer 31 functions as the second coating and the film 29 functions as the third coating, and the second and/or the third coating is made as a solidified substance. In this case, thus, three separate coatings have been applied. Moreover, the example shows that the third coating of the tongue side and the third coating of the groove side in coupled condition extend as far as to the upper side of the tongue in order to adjoin each other there, such that, in the case that these coatings consist of a moisture-repellent layer, a moisture barrier is formed at that location, too. In FIG. 10 is represented in dashed line how the third coating possibly can be applied over the second coating in an overlapping manner.

FIG. 11 represents a form of embodiment, wherein the chamfer 31 is formed by an impression or the like in the top layer 16. In this manner, the first as well as the second coating is formed by this top layer 16, whereas the third coating consists of the separate layer 29.

FIG. 12 represents a form of embodiment, wherein the first coating is formed by the top layer 16, which, for example, consists of laminate, and wherein the second and third coatings are made as a whole, for example, in the form of a transparent moisture-repellent layer. Herein, it is noted that the second coating herein extends over the decorative layer 32. Here, too, it is represented in dashed line how the second coating may be realized partially overlapping with the first coating. As the second and third coatings consist of a transparent material, such possible overlap is little or not at all visible at the upper side of the floor panel.

According to a fourth aspect, a number of examples of which are represented in FIGS. 13 to 20, the invention relates to a floor panel 1, of the type comprising at least a single- or multi-piece substrate 15, wherein said substrate at least partially consists of wood or wood-based material, wherein the floor panel 1, at least at two opposite sides 2-3, has profiled edge portions 6 that comprise coupling parts 7 allowing mechanically coupling two of such floor panels 1 to each other, wherein, in coupled condition, there is a locking in vertical as well as in horizontal direction, wherein the floor panel, at least at the actual upper side 8, is provided with a top layer 16 covering a first surface S1, wherein, viewed in cross-section, next to at least one of said sides 2-3, this top layer 16 terminates at a location P1, and wherein the floor panel 1 comprises a second surface S2 extending from said location P1 at least over a portion of the edge portion 6, characterized in that, viewed in cross-section, at the second surface S2 at least two different coatings, namely, a first coating 39 and a second coating 40, are applied which cover mutually differing, whether or not overlapping, zones Z1 and Z2, wherein, viewed along the contour of a side, the second coating 40 generally extends farther downward than the first coating 39, wherein the first as well as the second coatings are made layer-shaped and wherein the first and second coatings together cover only a portion of the contour of the edge portion 6, however, the second coating extends downward as far as a location P3, which, in the coupled condition of two of such floor panels, is in contact with the other floor panel. It is clear that this fourth aspect is not restricted to the forms of embodiment represented in the figures and that the references mentioned in the preceding general definition of the fourth aspect to the reference numbers of FIGS. 13 to 20 are included in this definition solely for clearness' sake. By the characteristic that the second coating 40 generally extends farther down than the first coating 39, it is intended that, when the contour of a lateral edge 2 or 3 is followed from the upper side 8 to the underside 20, the first coating 39 terminates at a certain point, whereas the second coating 40 still extends over at least a portion of the further contour.

By making use of at least two different coatings 39 and 40, the advantage is created that the coating of the side of a floor panel can be optimized individually in function of the zones, for example, in respect to appearance, sealing, applicability, finish, production speed and so on.

As the overall coating formed by the first coating 39 and second coating 40, at the respective edge portion 6, extends up to said location P3, the advantage is created that in the case of moisture penetration in between coupled floor panels a certain moisture barrier is formed at the surface of the respective edge portion at least up to this location, as substantially each kind of coating has a more or less sealing effect. Hereby, the most critical part—critical in respect to moisture penetration—of the surface of the edge portion is provided with a coating. Anyhow, beyond the location P3, the risk of moisture penetration is lower, in view of the fact that the coupling parts 7 adjoin each other there.

As the common coating formed by the first coating 35 and the second coating 40 covers only a portion of the contour of the respective edge portion, the advantage is obtained that the amount of product necessary for forming the coatings is kept restricted and that a mostly difficult application procedure for coating an entire contour is excluded.

As use is made of layer-shaped first and second coatings extending in their totality up to the location P3, no thickly provided cord-shaped sealing masses, which might disturb the good mechanical function of the coupling parts, have to be provided in between the floor panels. In the most preferred form of embodiment, such floor panel, at both edge portions of said sides, thus, is free of such thick, cord-shaped sealing masses and are they exclusively provided with coatings that are layer-shaped. Preferably, thus, at both edge portions of the opposite sides at least a first as well as a second layer-shaped coating are present and, from the upper side of the floor panel up to the location P3, exclusively layer-shaped and thus no thicker coatings are present.

Further, the floor panels according to the fourth aspect may show one or more of the following characteristics, which, depending on the application, may offer various advantages:
I. The characteristic that said two coatings 39-40 adjoin each other, whether or not being overlapping; this offers the advantage that no uncoated parts are present in between the zones Z1 and Z2 covered by each of these coatings 39-40, which is useful, amongst others, when both coatings 39-40 have a water- or moisture-sealing effect, such that then there is no intermediate zone where water indeed might easily penetrate and the floor panel 1 therefore might be damaged by swelling;
II. The characteristic that said two coatings 39-40 are made overlapping, whereby it is guaranteed with certainty that no intermediate uncoated zones are created in the case of deviations in the course of the edges of the coatings, and whereby in certain cases the coatings may be provided less accurately and therefore at higher production speeds;
III. The characteristic that the coating 39 of the uppermost zone Z1, or thus the zone situated closest to said location P1, is made as a strip of narrow width, preferably with a width of less than 3 millimeters or still better less than 2 millimeters, with the advantage that the application process can be controlled better and that a finer finishing in the proximity of the edge of the top layer 16 may be guaranteed, even with relatively high application speeds;
IV. The characteristic that the uppermost coating 39 starts on said location P1, as a result of which there are no untreated zones between the top layer 16 and the coatings 39-40;
V. The characteristic that the floor panel 1 at the respective side 2-3, viewed in cross-section, has a chamfer 31 next to said location P1 and that the first coating 39 extends at least partially and preferably entirely over the chamfer 31, whereas the second coating 40 is at least partially present on the actual side wall 41 below the chamfer 31, whereby the choice of material for the first coating may be optimized as a decor layer, for example, with a suitable color, thickness, gloss degree, pattern and the like, whereas the choice of material for the second coating may be optimized in function of the features desired to obtain at the actual side wall 41, such as protection against water or moisture penetration, preferably by means of a coating having almost no thickness, in order to obtain that the proper function of the coupling means is not hindered;
VI. The characteristic that said coatings 39-40 each cover at least a portion of the actual side wall 41, with the advantage that two coatings are present at the actual side wall 41, wherein the coating 39 extending from the location P2, from which the actual side wall 41 extends downward, then may optimized in function of a smooth finishing and application possibility along the upper edge of the actual side wall 41 and/or in function of the desired sealing between two adjacent floor panels 1, whereas the lower-situated coating 40 may be optimized, for example, in function of the application possibilities, waterproofness, and so on; it is noted that this may relate to a floor panel wherein, at the respective sides 2-3, the actual side wall 41 starts at said location P1, as well as to a floor panel 1 which is provided with a chamfer 31 and where the actual side wall 41 thus is situated below the chamfer 31;
VII. The characteristic that the lower edge 42 of the first coating is situated on the actual side wall 41 or at the location P2 where the actual side wall 41 starts, such that the first coating extends at least up to the location P2 where the floor panels 1 adjoin against each other or almost against each other, with the advantage that at the location P2 where two floor panels come together next to their upper side, another coating is present than further downward, whereby the first coating 39 then may be optimized in function of the features desired on the location P2 or on the area situated directly there below, whereas the second coating 40 then may be optimized in function of other desired features;
VIII. The characteristic that the upper edge 43 of the second coating 40 is situated at a distance below said location P1 where the top layer 16 terminates, whereby the application of this coating in most cases is less critical, as no precise delineation along the top layer has to be created.

The references to the reference numbers of one or more of the FIGS. 13 to 20 mentioned in the preceding paragraphs I to VIII have been included in these paragraphs exclusively for clearness' sake. Thus, the features described under I to VIII are not restricted to certain ones of the represented embodiments.

According to the fourth aspect, for the first coating preferably use is made of one of the following possibilities:
a foil;
a transfer film;
a lacquer, varnish, ink, polymer or other solidifying substance, amongst which also hot melt glue.

According to the fourth aspect, for the second coating preferably use is made of one of the following possibilities:
a lacquer, varnish, ink, polymer or other hardening substance, amongst which also hot melt glue;
a moisture-repellent substance.

According to the fourth aspect, the term “coating” should be interpreted in a broad sense and here may relate to a layer situated rather on top of the surface as well as a layer largely taken up into the substrate, which then mostly may be considered an impregnation.

Further, it is preferred that in embodiments according to the fourth aspect, the first coating preferably is formed of a substance forming a layer situated rather on top of the surface, whereas the second coating rather is a substance largely taken up in to the substrate and/or which is present on the surface thinner than the first coating. Hereby is avoided that in the possible overlapping area a too thick layer is created, which might complicate the mechanical joining of the floor panels.

Now, the fourth aspect is explained further by means of FIGS. 13 to 20. In these figures, the top layer 16, the first coating 39 and the second coating 40, for clearness' sake, in respect to the remainder of the floor panel 1 are shown thicker than in reality. In reality, this, anyhow, relates to thin layers.

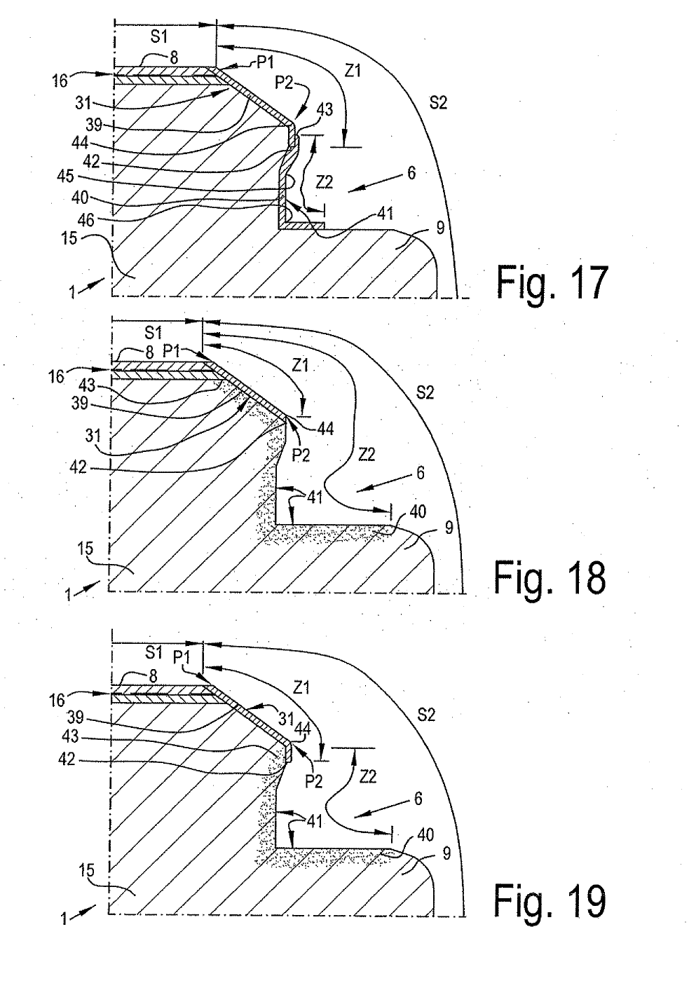

As has already been clarified above, P1 always is the location where the top layer 16 terminates at the edge of the floor panel 1. P2 always is the location where the “actual side wall” 41 of the respective floor panel 1 starts, by which the surface is meant which clearly is directed laterally, and the possibly adjoining thereto surface of tongue or groove. In the case of floor panels 1 without chamfer, such as in FIGS. 13 to 15, or with a chamfer 31 of which the top layer 16 continues, such as in FIG. 16, the “actual side wall” 41 starts at the edge of the top layer 16, whereas in the case of floor panels 1, which are provided with a separately formed chamfer 31, such as in FIGS. 17 to 20, the “actual side wall” 41 starts at the lower edge 44 of the chamfer 31.

More specifically, FIGS. 13 and 14 represent a form of embodiment in which the actual side wall 41 starts directly at the edge of the top layer 16. The second coating 40 is situated with its upper edge 43 at a distance beneath the edge of the top layer 16, such that, when applying the coating 40, no narrow tolerances have to be handled. The first coating 39 is made overlapping to the second coating 40 and in the form of a relatively narrow strip. This form of embodiment thus shows the aforementioned characteristics I, II, III, IV, VI, VII and VIII.

In the variant of FIG. 15, the overlap is made in reverse sense.

In the variant of FIG. 16, there is no overlap, and the two coatings 39-40 precisely adjoin against each other. Moreover, in the top layer itself a chamfer 31 is integrated, for example, by an impression of the upper surface.

FIG. 17 shows an embodiment in which at the upper edge of the floor panel 1 a chamfer 31 is realized in that a material portion is removed. The first coating 39 is of a decorative nature and masks the material of the substrate 15 and preferably also prevents moisture penetration. Preferably, it consists of a transfer print or lacquer, as such coatings offer high-quality decorative surfaces. In view of the fact that the second coating 40 is situated lower than the chamfer and thus is not visible in the coupled condition of two floor panels 1, this coating may be formed of another material, with the advantage that a material may be chosen, which, for example, is less expensive, may be applied in a smooth manner, also in the recessed portion 45 and the inner corner 46, such as, for example, a hardening substance that is easy to apply by spraying, for example, a varnish, impregnation agent or the like. In the example, the first coating 39 continues somewhat up to below the lower edge of the chamfer, whereby an overlap area can be realized on the actual side wall 41, which overlap is situated at a distance below the chamfer, with the advantage that the second coating 40, even with an irregular overlap, never is present at the visible side of the chamfer.

FIG. 18 represents a variant, in which the second coating 40 consists of an impregnation with a moisture-repellent or waterproofing agent over the entire edge portion, whereas the first coating 39 consists of a decorative coating provided on the surface of the chamfer after the impregnation with the aforementioned agent. The overlap then coincides or almost coincides with the entire zone Z1.

FIG. 19 represents a variant of FIG. 18, wherein said impregnation is performed exclusively on the actual side wall, in other words, on the portion below the chamfer, whereas the preferably also water-tight decorative first coating 39 is realized overlapping to the second coating 40. An advantage of this embodiment consists in that the impregnation does not extend up to directly below the top layer 16, by which is excluded that a possible swelling of the substrate as a result of the impregnation would continue up into the top layer 16, in other words, does not result in that the top layer 16 is pushed upward.

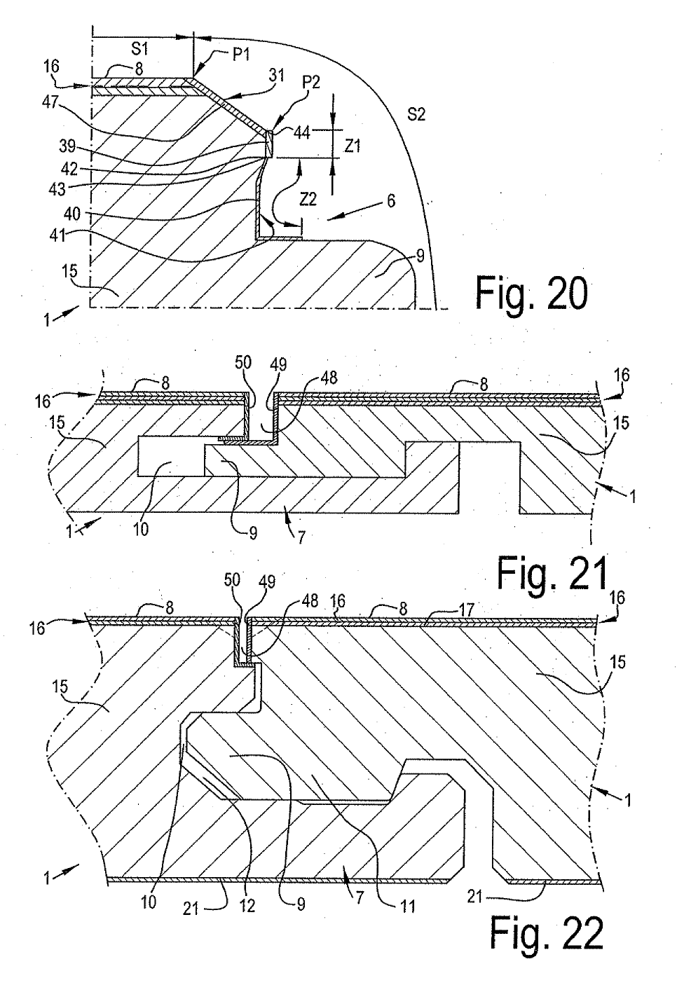

FIG. 20 represents a variant, in which in the edge region three coatings, 47, 39 and 40, respectively, are applied. Herein, the coatings 39 and 40 form a first coating and a second coating, which both are provided on the actual side wall 41, whereas the coating 47 forms a third coating, which in this case covers the chamfer. In this case, the coating 39 consists, for example, of a thin, preferably elastic, sealing strip, which is clamped in connected condition of two floor panels and forms a sealing against penetration of moisture or the like. The coating 40 consists of a moisture-repellent or water-tight coating for protecting the substrate against penetration of water or moisture, in case still a penetration might occur at said sealing. The coating 40 extends downward along the contour of the respective coupling part, at least as far as the location where the latter part, in coupled condition, comes into contact with the coupling part of the other floor panel. According to a non-represented variant, the second coating 40 continues up to the backing layer situated at the underside of the floor panel 1. The third coating 47 forms a decorative coating for the surface of the chamfer 31 and thereby also forms a barrier against moisture penetration.

Further, it is noted that according to the fourth aspect, by “coating” always a layer is meant which either is entirely taken up into the coated surface, for example, in case of impregnation, or is a layer or the like, wherein the thickness of material of which this layer consists and which is situated on top of the coated surface is thinner than 1 millimeter and still better is thinner than 0.2 millimeters. More particularly is preferred that such coatings are made as a film consisting of a print, color or coating substance solidified on the surface.

It is noted that the forms of embodiment of FIGS. 5, 10 and 12 also correspond to the fourth aspect of the invention, as in this form of embodiment also such two different coatings are applied in the edge portion, said coatings in this figures being indicated by references 32 and 29.

Finally, the invention also relates to an independent fifth aspect. This fifth aspect relates to floor panels, which, at their edges, are provided with coupling parts providing, in coupled condition, for an intentional gap between the actual side walls of the floor panels, or at least allow interconnecting the floor panels in such a manner that such intentional gap is created. Herein, this does not relate to gaps occurring as a result of manufacturing tolerances, but rather to gaps, of which the presence is desired for any reasons whatsoever. FIGS. 21 to 23 represent three examples of coupled floor panels, wherein such intentional gap 48 is present. The example of FIG. 21 relates to a coupling as known from WO 94/26999, wherein a desired free play is present, such that a gap 48 may be present. The example of FIG. 22 relates to a coupling of the type as described in WO 2005/068747, wherein at the upper edge an intentional gap is present between the coupled floor panels. FIG. 23 relates to an expansion coupling of the type as described in the Belgian patent application No. 2006/0534 of the applicant, wherein at that moment when two floor panels are joined into each other, an initial condition is created in which, as illustrated in the figure, at the top a gap 48 is present between the floor panels 1.

A disadvantage of floor panels where, when two of such floor panels are interconnected, such intentional gap is obtained, consists in that the substrate, which is situated under the top layer and in which the gap usually is formed, can easily take up moisture, not only when spilling water or the like or when cleaning with a moist cloth, however, also simply by taking up humidity from the ambient air. Another disadvantage consists in that an edge portion formed of a wood-based substrate often has a relatively less smooth surface, such that dust and the like penetrating into the gap will more or less remain hooked up and consequently are less easy to remove from the gap. Another disadvantage consists in that such intentional gap may be relatively wide, as a consequence of which in certain embodiments the side walls of the gap will become visible to the naked eye. As the gap extends up into the substrate and the appearance of the substrate mostly differs a lot from the appearance of the top layer and/or is not attuned to the latter, a disturbing effect is created.

Thus, the fifth aspect of the invention relates to a floor panel in which, when two of such floor panels are coupled to each other, a intentional gap is present, however, wherein a solution, or at least an improvement, to one or more of the aforementioned problems is offered. To this aim, the invention according to the fifth aspect relates to a floor panel, of the type comprising at least a single- or multi-piece substrate upon which a top layer is present, wherein this substrate at least partially consists of wood or wood-based material, wherein the floor panel, at least at two opposite sides, has profiled edge portions, which comprise actual side walls as well as comprise coupling parts allowing to couple two of such floor panels mechanically to each other, wherein these coupling parts, in coupled condition of two of such floor panels, on the one hand, effect a locking in vertical as well as horizontal directions, and on the other hand, provide for an intentional gap between the actual side walls of the floor panels, or at least allow that the floor panels can be engaged into each other in such a manner that such intentional gap is created, the gap having side walls that are formed at least partially by the substrate, characterized in that the side walls of said gap at the bottom, whether or not by the intermediary of other walls, extend up to each other, and that at least on said side walls, a fixed coating is provided, such that the gap still will exist in the presence of this coating, wherein the coating covers at least a portion of the wall of the substrate in the gap. By a fixed coating, herein a coating is meant, which, once applied, can not shift in a substantial manner. By making use of a fixed coating, it is guaranteed that the intentional gap is maintained, and is excluded that by displacing the coating, for example, by scraping off and upsetting the coating material, the gap might be filled partially or entirely, as a consequence of which the effect intended by the gap, whatever this effect may be, might be lost. As fixed coatings, amongst others, prints, entirely solidifying substances, such as color, plastic coatings and the like are intended. An example of a non-fixed coating are certain waxes, such as certain paraffins, which remain present at the surface as a viscous substance and therefore may be upset and agglomerate in the gap.

As a fixed coating, at least according to the fifth aspect of the invention, also a coating is considered which is non-sticky, which paraffin on the contrary is. By making use of a non-sticky coating, it is excluded that dust, dirt and the like strongly adhere to the gap and agglomerate, as a consequence of which the function of the gap might be disturbed. Moreover, as a result of such stickiness, the dust and dirt will be difficult to remove from the gap.

Preferably, a coating is applied that forms a layer, which is at least partially present on top of the material of the substrate. Hereby, a relatively smooth surface is obtained, as a result of which the adherence of dust and dirt is counteracted.

In the examples of FIGS. 20 to 23, such fixed coating provided according to the present invention is indicated by references 49 and 50.

As represented in FIGS. 21 to 23, preferably all walls which, in the coupled condition of two of such floor panels 1, border the gap 48 are provided with such fixed coating.

According to a preferred form of embodiment, the fixed coating consists of a moisture-repellent substance. More particularly, it is preferred that a watertight layer is applied.

According to another form of embodiment, the fixed coating is made in the form of a decorative layer, by which is meant that this coating is colored and/or provides for a pattern. The general coloring tint herein may be adapted to the decor present at the upper side of the floor panel or, according to an alternative, may be chosen such that the presence of the gap is underlined, for example, by coloring the walls of the gap black.

It is clear that the fourth and fifth aspects of the invention primarily are intended for floor panels with coupling parts allowing for a glue-free connection between floor panels and which are at least partially formed from the substrate, for example, by means of a milling treatment. More particularly are these aspects of importance with a substrate consisting of MDF or HDF, as then, by means of the aforementioned aspects and by choosing appropriate materials, it can be prevented that the substrate absorbs moisture and swells. Still more particularly, these aspects are of importance with laminate floor panels, more particularly with a thin top layer on the basis of resin-impregnated paper layers, such as a traditional decor layer and overlay.

The present invention is in no way limited to the forms of embodiment described by way of example and represented in the figures, on the contrary may such methods and floor panels be realized according to various variants, without leaving the scope of the invention.

1-37. (canceled)

38. Floor panel, comprising a single or multi-piece substrate comprising wood or wood-based material, said panel at least at two opposite sides having profiled edge portions which at least comprise coupling parts, and at least at one of the sides having a chamfer, such that the floor panel includes at least a first surface formed by the actual upper side of the floor panel, a second surface formed by the surface of said chamfer, and a third surface formed by the portion of the profiled edge portion extending below said chamfer, wherein, on the first, second and third surfaces, a first, second and third coating, respectively, are provided wherein at least one of said coatings is in the form of a solidified substance.

39. The floor panel of claim 38, wherein the first, second and third coatings each are separate coatings.

40. The floor panel of claim 38, wherein the first and second coatings on the first and second surfaces are one and the same material, said material comprising partially the first and partially the second coating, and wherein said third coating is a separate cooling.

41. The floor panel of claim 38 or 39, wherein the first and second coatings are disposed in an overlapping manner.

42. The floor panel of claim 38 or 39, wherein the second and the third coatings are disposed in an overlapping manner.

43. The floor panel of claim 38 or 39, wherein said first coating comprises any of:
a laminate layer, comprising a resin, and optionally a laminate;
a foil;
a lacquer or varnish;
a polymer; or
an ink, optionally in the form of a print.

44. The floor panel of claim 38 or 39, wherein the second coating comprises any of:
a foil;
a transfer film;
a lacquer, varnish, or ink; or
a polymer.

45. The floor panel of claim 38 or 39, wherein the third coating comprises any of:
a foil;
a transfer film;
a lacquer, varnish, or ink;
a polymer; or
a moisture-repellent substance.

46. The floor panel of claim 38, wherein the floor panel is a laminate floor panel having a top layer comprising a resin material, which top layer defines the first coating, and wherein the second and third coatings are formed as a unitary colorant layer.

47. The floor panel of claim 38 or 40, wherein the floor panel is a laminate floor panel, including a top layer comprising a resin, which top layer defines the first coating; wherein the second coating is a decorative layer, said second coating being optionally integral with the first coating; and wherein the third coating comprises a moisture-repellent layer, and partially overlaps said second coating.

48. Floor panel, comprising at least a single- or multi-piece substrate and having a top layer at its upper side and two opposite sides having profiled edge portions which at least comprise coupling parts; and wherein said substrate at least partially comprises wood or wood-based material; and wherein the floor panel, on one or more of said profiled edge portions, has a transparent or translucent and moisture-repellent film-shaped coating, which covers all or part of the entire surface of the respective profiled edge portions and which extends from the surface of the respective profiled edge portion as far as onto said upper side of the floor panel.

49. The floor panel of claim 48, wherein the film-shaped coating extends over the entire surface of the respective profiled edge portion.

50. The floor panel of claim 48 or 49, wherein the floor panel has a film-shaped coating on all sides or profiled edge portions, said coating extending from the respective side or from the respective profiled edge portion as far as onto said upper side of the floor panel.

51. The floor panel of claim 48 or 49, wherein the film-shaped coating is formed by a substance that has solidified from a liquid during or after application.

52. The floor panel of claim 48 or 49, wherein the film-shaped coating is a water-tight or substantially water-tight layer.

53. The floor panel of claim 48 or 49, wherein the film-shaped coating, with or without a moisture-repellent or waterproof top layer at the upper side of the floor panel and with or without a moisture-repellent or water-tight layer at the underside of the floor panel, constitutes an entirely complete moisture-repellent or water-tight encapsulation of the panel.

54. Floor panel, comprising at least a one- or multi-piece substrate, substrate comprising wood or wood-based material, wherein the floor panel, at least at two opposite sides, has profiled edge portions which comprise coupling parts configured so as to enable mechanically coupling two of such floor panels to each other; wherein, in coupled condition, there is a locking in vertical and horizontal directions; wherein the floor panel, at least at the actual upper side, is provided with a top layer covering a first surface; wherein, viewed in cross-section, next to at least one of said sides, the top layer terminates at a first location; said floor panel further comprising a second surface extending from said first location at least over a portion of the edge portion; wherein, viewed in cross-section, at the second surface at least two different coatings, including a first coating and a second coating, are applied and which cover mutually differing, and optionally overlapping, zones; wherein, viewed along the contour of a side, the second coating extends farther downward than the first coating; wherein the first and the second coating are made layer-shaped; wherein the first and second coating together cover only a portion of the contour of the edge portion, with the second coating extending downward as far as a second location, said second location, in the coupled condition of two of such floor panels, being in contact with the other floor panel.

55. The floor panel of claim 54, wherein the two coatings adjoin each other, optionally overlapping each other, and wherein on the edge portions of said sides exclusively layer-shaped coatings are applied.

56. The floor panel of claim 54 or 55, wherein the coating of an uppermost zone is made as a strip of narrow width.

57. The floor panel of claim 54 or 55, wherein the floor panel, viewed in cross-section, has a chamfer next to said first location and wherein the first coating extends at least partially over the chamfer, and wherein the second coating is at least partially disposed on a panel side wall located below the chamfer.

58. The floor panel of claim 54 or 55, wherein a lower edge of the first coating is disposed on a panel side wall or at the first location where the side wall starts, such that the first coating extends at least up to said first location where the floor panels abut against each other or almost against each other.

59. Floor panel, comprising at least a single- or multi-piece substrate upon which a top layer is disposed, wherein the substrate at least partially comprises wood or wood-based material; wherein the floor panel, at least at two opposite sides, has profiled edge portions, which comprise actual side walls as well as coupling parts configured so as to enable two of said floor panels to be coupled mechanically to each other; wherein the coupling parts, in coupled condition of two of such floor panels, effect a locking in vertical as well as horizontal directions, and provide for an intentional gap between the actual side walls of the floor panels, or at least enable the floor panels to be coupled in such a manner that such intentional gap is created; the gap having side walls that are formed at least partially by the substrate; wherein the side walls of said gap, at the bottom, extend up to each other; and wherein at least on said side walls, a fixed coating is provided, such that the gap is not closed by the coating; and wherein the coating covers at least a portion of the wall of the substrate in the gap.

60. Method for manufacturing floor panels having at least a single- or multi-piece substrate and having, at least at two opposite sides, profiled edge portions, which at least comprise coupling parts, wherein said substrate at least partially comprises wood
